(19) United States
(12) Patent Application Publication
(10) Pub. No.: US 2021/0308899 A1
(43) Pub. Date: Oct. 7, 2021

(54) METHOD OF MANUFACTURING A WOOD-BASED PANEL

(71) Applicant: Xylo Technologies AG, Niederteufen (DE)

(72) Inventor: Dieter DÖHRING, Großenhain (DE)

(21) Appl. No.: 17/056,138

(22) PCT Filed: May 30, 2018
(86) PCT No.: PCT/EP2018/064212

§ 371 Date: Nov. 17, 2020

(51) Int. Cl. B27N 3/00; B27N 3/04; B27N 3/12; B27N 3/06

(52) U.S. Cl. CPC B27N 3/002; B27N 3/06; B27N 3/12; B27N 3/04

(57) ABSTRACT

The present invention concerns a method for the manufacture of a wood-based panel comprising providing wood fibers which are impregnated with a phenolic resin, the ratio of resin (based on the solids content) to wood fibers being 10 to 50% by weight. The impreganted fibers are pre-compacted in a press at press temperatures below 110° C. to a chemically reactive fiber board and then pressed to compact panels at temperatures between 130 and 180° C.

### 1. FIELD OF INVENTION

This invention concerns a process for the production of wood-based panels, in particular highly compressed compact panels with a density of preferably more than 1,200 kg/m³. The panels are used, for example, as wall cladding, in sanitary areas or in furniture construction. A special further development of the invention lies in a process for the production of a flame retardant wood-based panel.

### 2. TECHNICAL BACKGROUND

A large number of wood-based panels, in particular so-called medium density wood fiber boards (MDF boards) or high density fiber boards (HDF boards), are known from the state of the art. They serve, for example, as a basic element or carrier plate for the production of furniture or floor coverings. Usually, a carrier board made of MDF or HDF is provided and a decorative paper impregnated with a melamine resin is applied to the top and, if necessary, also to the underside. The resins cure under the influence of heat and pressure, so that an abrasion and scratch-resistant surface is created. To increase the abrasion resistance, abrasion-resistant particles can be added to the surface before pressing, especially corundum.

For mechanically particularly demanding applications, so-called compact laminates according to EN 438 are produced. For this purpose, kraft papers, typically with a basis weight between 150 and 250 g/m², are impregnated with phenolic resins (for example, a 150 g/m² base paper has 218 g/m² after impregnation), cut to size and stacked several layers on top of each other. The outer layers usually consist of melamine resin impregnated decorative paper. This package is then pressed in multi-level presses between steel sheets at a specific pressing pressure between 7 and 10 MPa and temperatures usually between 140 and 170° C. The associated costs are extremely high, for example, when 150 g/m² kraft paper is used to produce a 13 mm thick compact board, about 70 to 80 sheets have to be stacked on top of each other.

The present invention therefore strives to improve the state of the art, by combining the two technologies described above and in particular by providing a more cost-effective process for manufacturing a wood-based panel, or more precisely a compact panel, with properties in accordance with EN 438 that is of good quality, dimensionally stable and mechanically resilient. A further aspect of the present invention is the provision of a process for the production of a compact panel which shows good behaviour in the event of fire, i.e. is resistant to fire. These and other tasks, which are specified in the following description or can be recognized by the skilled person, are solved with a process for the production of a wood-based panel according to claim 1 as well as with the further developments described in the subclaims.

### 3. DETAILED DESCRIPTION OF THE INVENTION

According to the present invention, a method for the production of a wood-based panel, respectively a wood-based compact panel, is provided. In a first step, wood chips are provided, as they are also used, for example, in the production of MDF boards. The wood chips are then processed (pulped/broken down) in a refiner into wood fibers. The duration of the wood chips in the refiner should preferably be 3 to 20 minutes, at a pressure of 4 to 16 bar. It is of advantage if the wood fibers are broken down much further in the cooking process compared to conventional MDF production. The wood fibers thus provided are however not glued with urea resin as it is typical for MDF and HDF production, but glued (impregnated) with a phenolic resin. The ratio of resin (based on the solids content in the normally liquid resin) to wood fibers is 10 to 50% by weight. The glued (impregnated) wood fibers are then placed e.g. on a forming belt, pre-packed and then pre-compacted in a double belt press at pressing temperatures below 110° C. to form a chemically reactive fiber board. It is very important that the temperatures in the press are chosen so that the phenolic resin does not chemically react. With such pre-compacted chemically reactive fiber boards, the binder is therefore not chemically crosslinked. After the double belt press, the fiber board strand is cut to size and the boards thus obtained are cooled. The high adhesiveness of the phenolic resin together with the more supple wood fibers, which are well broken down in the cooking process in the refiner, ensure that reactive fiber boards produced in this way have sufficient mechanical strength for further handling and transport purposes. This means that the panels can e.g. be ground, stacked and transported in large formats. The pre-compacted chemically reactive fiber board is subjected to a second process step and fed to a press, such as a discontinuous multi-level press, and then pressed at temperatures between 130 and 180° C. to form compact panels. The press cycle for this is well known to experts in the field of compact laminates and does not have to be explained in detail.

The two process steps or process stages described can be carried out with a significant time gap therebetween. The chemically reactive fiber boards have a service life of at least 6 weeks when properly stored, which is very advantageous for production logistics. When the pre-compacted reactive fiber board is compacted at the elevated temperatures, a chemical reaction and crosslinking of the binder occurs. If the chemically reactive fiber boards are provided with melamine resin impregnated decor papers on both sides before the second pressing step, decorative compact panels with properties known from EN 438 can be obtained. In particular, the mechanical properties of the compact panels can be further improved by additionally pressing a phenolic resin-impregnated kraft paper onto the top and bottom of the reactive fiber board below the decorative sheet.

Compared to the production of conventional compact boards or panels from kraft paper described above, the production costs for an inventive compact panel are much lower, since the production of kraft paper on a paper machine, impregnation of the same and stacking of many layers are no longer necessary.

The process steps described above are essential for the present invention, namely first the production of a pre-compacted, chemically reactive fiber board and in a second step the subsequent compaction under pressure and heat to form a compact panel (wood-based panel). The pre-compaction must not lead to a chemical reaction of the resins, but must take place in such a way that a manageable intermediate product is produced.

Pre-compacting the fibers into a chemically reactive fiber board is preferably carried out in a continuously operating double belt press and the subsequent compacting and curing to a compact board or panel at elevated temperatures by means of a discontinuously operating press. It is essential that lower temperatures are selected during pre-compaction, so that the phenolic resin remains chemically fully reactive.

Preferably, the wood chips are processed into wood fibers using a refiner with a cooking time of 3-10 min, a pressure of 8-15 bar and a refiner energy of 25-70 kW/t. In any case, the conditions must be chosen in such a way that the fibers are disintegrated as evenly as possible and that no larger wood particles are present. Preferably, the ratio of resin (based on solid content) to wood fibers is 10 to 40 weight percent, more preferably 15 to 30 weight percent and most preferably 15 to 25 weight percent. For example, 400 kg of phenolic resin (solid resin) is added to one ton of wood fibers, i.e. at a ratio of 40 percent by weight, whereby the water content present in the liquid phenolic resin is not included in the calculation. Depending on the water content, the additional quantity must be adequately extrapolated. For a liquid phenolic resin with 50% solids content, according to this calculation example, 800 kg of liquid phenolic resin must be applied to one ton of fibers.

As mentioned above, the pre-compacting of the fibers into a chemically reactive fiber board should preferably be carried out in such a way that the phenolic resin remains chemically fully reactive. Depending on the selected temperature, a small proportion of the phenolic resin may react chemically, especially in the outer areas of the pre-compacted fiber board, which are close to the typically heated press plates or press belts. These chemical reactions should preferably be minimized or completely ruled out.

Preferably, the pre-compaction step is carried out in such a way that the pre-compacted fibers, i.e. the chemically reactive fiber board, have a density of 300 to 900 kg/m³, more preferably from 500 to 800 kg/m³ and even more preferably from 650 to 750 kg/m³. The final thickness of the compact panel, i.e. after the final pressing in the second pressing process, is largely determined by the basis weight (kg/m²) of the wood-fiber-resin mixture during shaping before the first pressing step. The density of the chemically reactive fiber board is not important, as it depends on the mass of material and not so much on the degree of pre-compaction. However, the optimum density of the chemically reactive fiber board is important for the handling and a sufficient mechanical strength of the chemically reactive fiber board and must be adjusted according to the press system. The densities given above for the pre-compacted chemically reactive fiber board lead to (intermediate) products that can be handled (transported, cut, provided with decor papers, etc.) and stored very well.

Preferably, the pre-compacted chemically reactive fiber boards are finally compacted at temperatures between 140 and 170° C., more preferably between 140 and 160° C. These temperature ranges lead to a safe chemical reaction of the resins, such as the phenolic resins, while still protecting the materials of the product to be manufactured and the pressing equipment.

The pre-compacted chemically reactive fiber boards are preferably compacted at a pressing pressure of 4 to 10 MPa, more preferably 7 to 9 MPa. These pressing pressures are used to produce high-quality, very dense wood-based panels, also known as compact panels. The density of these compact panels is at least 1,200 kg/m³, but preferably 1,450 to 1,550 kg/m³.

Fillers are preferably added to the binder (i.e. the phenolic resin). With the help of mineral fillers, various properties of the finished wood-based panel can be influenced. In particular, the flame behavior of the panel can be influenced, as will be explained in more detail below. For this reason, mineral fillers are preferably flame retardants, such as aluminium hydroxide or borates, or comprise such flame retardants.

Preferably the mineral fillers are added in an amount of 5 to 150% by weight based on the mass of the binder, based on the solids content of the resin in the binder. Even more preferably 10 to 100 weight percent and most preferably 35 to 90 weight percent are added. For example, an addition of 30 percent by weight of mineral fillers based on the mass of the binder means that 300 kg of mineral fillers are added for an amount of one ton of phenolic resin (based on the solids content again, i.e. for a liquid phenolic resin without the water content). The mineral filler is preferably added to the (liquid) phenolic resin before it is used for gluing/impregnating the wood fibers. According to this calculation example, 300 kg of mineral fillers must be added to 2,000 kg of liquid phenolic resin for a phenolic resin with 50% solids content. The wood fibers are thus glued with a filler/binder mixture, resulting in a very good distribution of the mineral fillers in the final board. If mineral fillers are added as flame retardants, the specified ranges are suitable for the finished wood fiber board to achieve a very good fire resistance quality.

Mineral fillers are therefore preferably added to the binder in a quantity and type so that the finished wood-based panel (which can also be referred to as a compact board or panel due to its high density) achieves a fire behavior quality of Bi according to DIN 4102-1 or better. The standards DIN 4102-1 and EN 13501-1 divide building materials into building material classes and fire protection classes according to their fire behavior. Legal requirements and guidelines specify which building material classes may be used in certain constructions. The classification into fire protection classes therefore plays a decisive role in the question of whether or not certain building materials, such as wood fiber boards, are suitable for certain areas of building projects. Class B1 building materials are flame-resistant and must not continue to burn on their own after the source of ignition has been removed. This means that the wood fiber boards according to the invention, if provided with suitable mineral fillers, can be used in a wider area of application than conventional compact boards made of phenolic resin impregnated papers according to EN 438 as described above. These are usually categorized as building materials of class B2, i.e. as “normally flammable”. The expert can immediately appreciate the considerable economic advantages.

Inorganic phosphorus compounds can also be added to the binder, preferably in combination with nitrogen-containing compounds such as amines. These compounds also serve as flame retardants and can have a favorable effect on the fire behavior of the finished wood fiber boards (i.e. the wood-based panels), so that they can be classified as class B1 building material.

Mineral fillers in the form of particles are also preferred, preferably with an average particle size d50 of 10 nm to 150 μm, more preferably from 500 nm to 50 μm and most preferably from 800 to 900 nm. The mineral fillers can be obtained commercially by respective suppliers. The particle size indicated by the suppliers is sufficiently precise for the intended purposes, since the exact size of the particles is not relevant, as the particles may be applied in a wide range of sizes. Alternatively, the relevant FEPA (Federation of European Producers of Abrasives) norms can be applied, that define particle sizes and size distribution. Generally, the smaller the particles, the better the distribution in the resin and in the composite. However, it must be ensured that agglomerates of filler particles are avoided as far as possible or that such agglomerates are mechanically destroyed, for example.

Preferably, the wood chips are processed (pulped/broken down) into wood fibers at a pressure of 5 to 16 bar, more preferably 6 to 15 bar and most preferably 8 to 15 bar. These pressure conditions lead to a good quality of the wood fibers while at the same time ensuring economical process values.

The duration of the pulping of the wood chips to wood fibers in the refiner is preferably 3 to 18 minutes, more preferably 3 to 15 minutes and most preferably 3 to 10 minutes. It has been shown that these exposure times, especially at the specified pressure values, lead to high-quality wood fibers.

Preferably the wood fibers are applied (impregnated/glued) with binder (e.g. phenolic resin) in a blow line. The binder, such as liquid phenolic resin, is injected directly into the fiber flow in the blow line. This process leads to a very homogeneous glue distribution. In principle, the general expertise for the production of MDF boards can be used for the production of the wood fibers as well as for the gluing of the same. For example, it is generally preferred that the wood fibers are dried to about 8 to 12% wood moisture (Atro) before glue application. Alternatively, and also preferably, the wood fibers can also be applied with the binder using mechanical glue application. If larger quantities of fillers are introduced into the phenolic resin, mechanical glue application of the fibers in known mixing devices can also be of advantage.

Pre-compacting to a chemically reactive fiber board is preferably carried out in a continuous press, whereby the pressure profile is selected or carried out depending on the press length such that the pre-compacted fiber board has a density of 300 to 900 kg/m³ and more preferably of 650 to 750 kg/m³. In this way, a suitable pre-compacted product is created, which is well suited for final pressing into an inventive wood-based panel and which is easy to handle due to its mechanical properties.

Pre-compaction of the wood-fiber-resin mixture (the glued wood fibers) to chemically reactive fiber boards is preferably done at elevated temperatures of the mixture, which should not exceed 110° C., however. The temperature of the wood-fiber-resin mixture during pre-compaction is therefore preferably between 30 and 110° C., more preferably between 50 and 105° C., even more preferably between 60 and 100° C., and most preferably between 70 and 100° C. The increased temperatures improve the handling of the wood-fiber-resin mixture and facilitate the pre-compaction of the mixture due to the improved viscosity of the resin.

This is particularly preferably achieved by pre-compacting to chemically reactive fiber boards in a continuous press at a press belt temperature of 15 to 150° C., preferably 30 to 140° C., more preferably 60 to 140° C. and most preferably 70 to 110° C., so that the core temperature of the chemically reactive fiber boards to be produced does not exceed 110° C. As mentioned at the beginning, a chemical reaction of the binder should be avoided or minimized during the pre-compaction of the glued wood fibers. For this it is necessary that the temperature of the press belts is not too high during pre-compaction or that the wood fibers are guided through the continuous press at sufficient speed. A certain elevated temperature is extremely advantageous for the process because firstly, it has proved difficult to ensure a uniform belt run in the continuously operating press at too low temperatures and secondly, an elevated temperature improves the tackiness of the resin-fiber mass, so that a press strand is obtained that can be easily handled after the press, as for example sawn to size, sanded if necessary and stacked.

In principle, the wood fibers are preferably fed to the gluing step with a moisture content of 2 to 8%, preferably 3 to 5%. The wood fibers are thus preferably dried in a dryer after the wood chips have been broken down before they are fed into the gluing process.

The final pressing of the chemically reactive fiber boards to wood-based panels, which are also referred to herein as compact panels, should preferably be carried out in such a way that the final panels have a density of 1,200 to 1,900 kg/m³, preferably of 1,400 to 1,650 kg/m³ and even more preferably of 1,450 to 1,550 kg/m³.

In a preferred further development, the pre-compacted chemically reactive fiber boards are provided with decorative, melamine resin-impregnated papers before being pressed into wood-based panels. When the pre-compacted fibers are finally pressed, the melamine resin in the papers will react due to heat and pressure, resulting in a bond between the decorative paper and the actual board. This step is known in principle from the production of compact laminates or furniture panels, so that reference is made to this well-known technology for further details.

In a preferred embodiment, the pre-compacted chemically reactive fiber boards are provided with phenolic resin-impregnated kraft papers on both sides or on one side, preferably however on both sides, before the final compaction into panels. Decor papers impregnated with melamine resin can be placed on the outer side (i.e. the kraft papers) before pressing. In this way, decorative panels with particularly good mechanical properties are obtained.

In the following, the method according to the invention is described by means of an example. As a starting point, wood chips consisting of 65% beech wood and 35% pine wood were provided and processed (pulped/broken down) in a refiner, whereby the cooking time in the refiner was 9 minutes, the pressure 12 bar and the grinding energy 60 kW/t. The resulting wood fibers were then pre-dried and sprayed with an aqueous phenolic resin in a blow line. Approximately 20 kg of solid resin were sprayed onto 80 kg of dry fibers. This corresponds to a ratio of resin (based on the solids content) to wood fibers of 25% by weight. The aqueous phenolic resin used had a solid resin content of approx. 60% and a water content of approx. 40%. Thus, the solids content in the liquid or aqueous phenolic resin was 60%, so that in the given example approx. 33 kg of liquid phenolic resin was added to the dry fibers (60% of 33 kg of liquid resin corresponds to 20 kg of solid resin). The glued (impregnated) fibers were dried to a moisture content of 3 to 5% before further processing. The glued and dried fibers were then placed on a forming belt and spread evenly thereon. The spreading mass was 9 kg/m². Before the pre-compaction step according to the invention, the spread fibers were slightly compressed and the fiber strand formed in this way was then fed to a continuously operating MDF press. The belt temperature of the press was set to 95° C. This is fundamentally different from the production of MDF or HDF boards, where the belt temperature is significantly above 150° C. The low belt temperature during pre-compaction does not allow any chemical reaction of the resins, so that the resulting pre-compacted fiber board remains chemically reactive. However, the viscosity of the resin respectively the glued wood fibers is advantageously improved, so that the pre-compaction is more uniform and homogeneous. The feed rate was 0.8 m/s and the pressure profile was selected in such a way that after the MDF press there was a pre-compacted, continuous fiber board strand with a density of about 650 to 700 kg/m³ and a thickness of 12 to 14 mm at a moisture content of 3.5 to 5%.

In this example, the chemically reactive fiber board strand formed in this way was cut into boards measuring 2,800×2,070 mm. These pre-compacted, chemically still reactive fiber boards were then subjected to a further build-up: First, a melamine resin-impregnated white decorative paper was placed on the pre-compacted fiber board. The paper weight without resin was about 100 g/m² and the resin content was about 135 g solid resin on 100 g paper. This package of paper and board was fixed between two press plates and placed in a multi-level press. The fiber board was pressed in the press at a pressure of 8 MPa and a temperature of 160° C. for about 15 minutes. The press was then cooled to approx. 35° C., the pressure reduced and the press opened. The resulting board, which can also be called a compact board, was still 6 mm thick and was characterized by the following values:
Thickness: 6.0 mm
Density: 1.480 kg/m³
Boiling test in boiling water according to EN 438-2.12: 1.3% increase in mass and grade 5 according to optical evaluation;
Resistance to moist heat according to EN 438-2.14 with an increase in mass of 1.8% and degree 5 according to optical evaluation;
Resistance to impact with large ball according to EN 438-2.21: 2,700 mm;
Bending strength according to EN ISO 178: 127 MPa;
Young's modulus according to EN ISO 178: 11,500 MPa;
Resistance to dry heat at 160° C. according to EN 438-2.16: stage 5;
Resistance to humid heat at 100° C. according to EN 438-2.18: stage 5;
Dimensional stability at elevated temperature according to EN 438-2.17: 0.2% longitudinal and 0.35% transverse.

The above process example was modified by adding a flame retardant to the binder to achieve a wood-based panel of fire protection class B1. The wood fibers were pulped as described in the first example. However, the phenolic resin binder used was mixed with aluminium hydroxide, and 35 kg of aluminium hydroxide was dosed to 65 kg of liquid resin (at a solids content of 58% this corresponds to 37.7 kg of resin) and the mixture was stirred. The aluminium hydroxide had an average grain size of 57 μm. The wood fibers were then mixed in a mechanical gluing device with the mixture of binder and aluminium hydroxide in a ratio of about 1:1, i.e. 1 kg mixture to 1 kg wood fiber. The glued fibers were then dried to a moisture content of 4.5 to 6% and further processed as in example 1. The resulting board had a density of 1,650 kg/m³, a thickness of 6 mm and reaches class B1 according to DIN 4102-1, making it flame-resistant and suitable for construction projects where class B1 building materials are required. The pre-compacted chemically reactive fiber board can basically also be produced in discontinuous multi-level presses with the same fiber preparation and gluing as described above, as was previously customary for MDF production.

### 4. DESCRIPTION OF PREFERRED EMBODIMENTS

In the following, the invention is explained in more detail with reference to the attached figures.

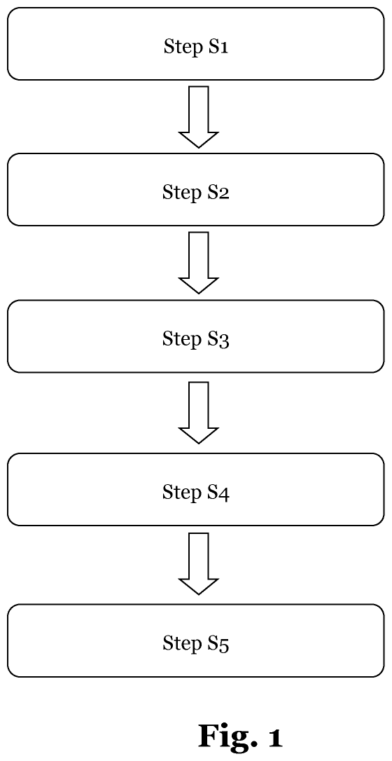

FIG. 1 is a schematic block diagram of a sequence of an inventive process; and

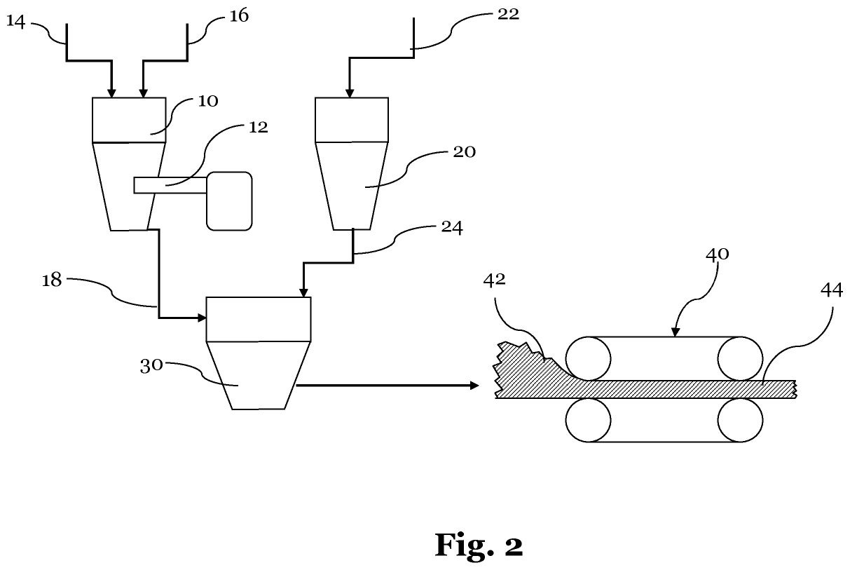

FIG. 2 shows schematically a production line for an inventive wood-based panel.

FIG. 1 shows a schematic flow chart for an inventive process for the production of a wood-based panel. In step S1, wood chips are provided. In step S2, the wood chips are processed into wood fibers by pulping them in a refiner for a few minutes at a pressure of 4 to 16 bar. In step S3, the wood fibers are glued with a phenolic resin, for example using a blow line or a mechanical gluing system known from MDF production. In step S4, the glued wood fibers are pre-compacted into a chemically reactive fiber board in a moulding press at pressing temperatures below 110° C. and in step S5 the pre-compacted fiber boards are pressed into the desired panels at temperatures between 130 and 180° C. It is clear to the skilled person that further process steps are possible between, before and after the mentioned processing steps, such as in particular drying of the wood chips and/or the wood fibers or the application of melamine resin-soaked kraft papers, cleaning of the wood chips and/or the produced wood fibers, etc.

FIG. 2 schematically shows a line for the production of an inventive wood-based panel. Wood chips are fed to a refiner 10 by means of a transport device 14. In Refiner 10, the wood chips are broken down into wood fibers and these are then fed to a dryer 12, where they are dried. From dryer 12 the wood fibers are fed to a gluing plant 16, where they are applied with a liquid phenolic resin. The glued fibers 40 are deposited on a transport device and fed to a double belt press 20 for pre-compaction. In belt press 20, the press belt temperatures are increased but kept well below 110° C. to avoid a chemical reaction of the resin in the glued fibers 40. At the exit of the double belt press 20 a chemically reactive pre-compacted fiber board 42 is provided, which has a density of about 650 to 750 kg/m³. This pre-compacted fiber board 42 is then fed to a high-pressure multi-level press 30 for final compaction. In this press 30, the fiber board 42 is further compacted using heat and pressure and in particular the binder is chemically crosslinked. The second press 30 operates at considerably higher temperatures than the first continuously operating press 20 for pre-compaction. In particular, the temperatures of the second press 30 are around 130 to 180° C. In addition, a considerably higher specific pressing pressure of up to 10 MPa is applied in the second press. After the pressing process at press 30, a panel 44 with a density of approx. 1,600 kg/m³ is present. The panel 44 can be subjected to further processing steps and in particular can be cut to the desired sizes.

### REFERENCE CHARACTER LIST

10 Refiner

12 Dryer

14 Wood chips

16 Glueing plant

20 Double belt press for pre-compacting

30 Double belt press for final compaction

40 Glued fibers

42 Pre-compacted fiber board

44 Finished wood-based panel

1. A method for manufacturing a wood-based panel comprising the following steps in the indicated order:
Provision of wood chips;
Breaking down the wood chips into wood fibers in a refiner for 3 to 20 minutes at a pressure of 4 to 16 bar;
Gluing the wood fibers with a phenolic resin, the ratio by weight based on the solids content of resin to wood fibers being 10 to 50%;
Pre-compacting the fibers in a press at pressing temperatures below 110° C. to form chemically reactive fiber boards; and
Pressing the pre-compacted fiber boards into panels at temperatures between 130 and 180° C.

2. The method according to claim 1, wherein an amount of power of 25 to 70 kW/t is applied when the wood chips are broken down.

3. The method according to claim 1, wherein the ratio by weight based on the solids content of resin to wood fibers is 10 to 40%, more preferably 15 to 30% and most preferably 15 to 25%.

4. The method according to claim 1, wherein the pre-compaction of the fibers is carried out in such a way that the phenolic resin does not undergo any chemical reaction.

5. The method according to claim 1, wherein the pre-compacted chemically reactive fiber boards have a density of 300 to 900 kg/m³, more preferably from 500 to 800 kg/m³ and even more preferably from 650 to 750 kg/m³.

6. The method according to claim 1, wherein the pressing of the pre-compacted chemically reactive fiber boards to panels takes place at temperatures between 140 and 170° C., more preferably between 140 and 160° C.

7. The method according to claim 1, wherein the pressing of the pre-compacted chemically reactive fiber boards to panels takes place at a pressing pressure of 4 to 10 MPa, preferably 7 to 9 MPa.

8. The method according to claim 1, wherein mineral fillers are added to the binder.

9. The method according to claim 8, wherein the mineral fillers are added in an amount of 5 to 150% by weight based on the mass of the binder, preferably 10 to 100% by weight and most preferably 35-90% by weight, based on the solids content of the binder.

10. The method according to claim 8, wherein the mineral fillers comprise flame retardants, such as in particular aluminum hydroxide or borates.

11. The method according to claim 1, wherein mineral fillers are added to the binder in a type and quantity so that the finished wood fiber panel achieves a fire behavior quality of B1 according to DIN 4102-1 or better.

12. The method according to claim 1, wherein inorganic phosphorus compounds are added to the binder, particularly preferably in combination with nitrogen-containing compounds such as amines, and the mineral fillers are added to the binder and the mineral fillers are particles with an average particle size of 10 nm to 150 μm, preferably 500 nm to 50 μm and most preferably 800-900 nm.

13. (canceled)

14. The method according to claim 1, wherein the step of breaking down the wood chips into wood fibers is carried out at a pressure of 5 to 16 bar, preferably 6 to 15 bar and most preferably at 8 to 15 bar, and the step of breaking down the wood chips into wood fibers takes place in the refiner for a duration of 3 to 18 minutes, preferably 3 to 15 minutes and most preferably for a duration of 3 to 10 minutes.

15. (canceled)

16. The method according to claim 1, wherein the gluing of the wood fibers with binder is carried out in a blow line.

17. The method according to claim 1, wherein the wood fibers are glued with binder by means of mechanical gluing, and the ratio by weight based on the solids content of binder to wood fibers is 10 to 50%, more preferably 15 to 40% and most preferably 15 to 25%.

18. (canceled)

19. The method according to claim 1, wherein the pre-compacting to chemically reactive fiber boards is carried out in a continuous press in such a way that the fiber boards are pressed to a density of 300 to 900 kg/m³ and preferably to 650 to 750 kg/m³ and the temperature of the glued wood fibers during pre-compaction is between 30 and 110° C., more preferably between 50 and 105° C., more preferably between 60 and 100° C., and most preferably between 70 and 100° C.

20. (canceled)

21. The method according to claim 1, wherein the pre-compaction to chemically reactive fiber boards is carried out in a continuous press at a temperature of the press belts of 15 to 150° C., preferably of 30 to 140° C., further preferably of 60 to 140° C. and most preferably of 70 to 110° C., such that the core temperature of the chemically reactive fiber boards to be produced does not exceed 110° C., and the pre-compacted chemically reactive fiber boards are compacted to panels having a density of 1,200 to 1,900 kg/m³, preferably 1,400 to 1,650 kg/m³ and even more preferably 1,450 to 1,550 kg/m³.

22. The method according to claim 1, wherein the wood fibers are fed to the gluing step with a moisture content of 2 to 8%, preferably 3 to 5%.

23. (canceled)

24. The method according to claim 1, wherein the pre-compacted chemically reactive fiber boards are provided with decorative melamine resin-impregnated papers before being pressed into panels.

25. The method according to claim 1, wherein the pre-compacted chemically reactive fiber boards are provided with phenolic resin-impregnated kraft papers on both sides or one side before the step of pressing into panels.
